(19) United States
(12) Patent Application Publication
(10) Pub. No.: US 2014/0283442 A1
(43) Pub. Date: Sep. 25, 2014

(54) STALK INOCULATION SYSTEMS AND METHODS

(71) Applicants: Robert John Thomas, III, Ottawa, IL (US); Jeffrey W. Hartsook, Madrid, IA (US); Ana Paula da Silva Dias, Sycamore, IL (US); George J. Baley, Webster Groves, MO (US); Harindra Manilal William, Ames, IA (US)

(72) Inventors: Robert John Thomas, III, Ottawa, IL (US); Jeffrey W. Hartsook, Madrid, IA (US); Ana Paula da Silva Dias, Sycamore, IL (US); George J. Baley, Webster Groves, MO (US); Harindra Manilal William, Ames, IA (US)

(73) Assignee: MONSANTO TECHNOLOGY LLC, St. Louis, MO (US)

(21) Appl. No.: 14/008,648

(22) PCT Filed: Mar. 28, 2012
(86) PCT No.: PCT/US12/30798

§ 371 Date: Oct. 1, 2013

Related U.S. Application Data
(60) Provisional application No. 61/470,622, filed on Apr. 1, 2011.

(51) Int. Cl. A01G 7/06; A01G 1/00

(52) U.S. Cl. CPC A01G 7/06; A01G 1/001
USPC 47/1.5; 47/58.1 R

(57) ABSTRACT

In various embodiments, the present disclosure provides an automated mobile inoculation system (10) for inoculating a plurality of plants with a desired pathogen at a high-throughput. The system includes a chassis (14) having a plurality of wheels (18, 22) rotationally mounted thereto such that the system (10) is terrestrially mobile. The system additionally includes an inoculum dispensing system (126) structured and operable to controllably dispense an inoculum comprising a desired pathogen onto a target zone of each of a plurality of plants in opposing rows of plants in a plot as the system traverses the ground between the opposing rows of plants. The system further (10) includes at least two abrading arm assemblies (54) connected to the chassis (14) and biased outward, away from the chassis, wherein the abrading arm assemblies are structured and operable to puncture, lacerate, cut and/or abrade the target zone of each plant as the system traverses (10) the ground between the opposing rows of plants.

### CROSS-REFERENCE TO RELATED APPLICATIONS

This application claims the benefit of U.S. Provisional Application No. 61/470,622, filed on Apr. 1, 2011. The disclosure of the above application is incorporated herein by reference in its entirety.

### FIELD

The present teachings relate to systems and methods for screening plants for disease tolerance.

### BACKGROUND

The statements in this section merely provide background information related to the present disclosure and may not constitute prior art.

In plant breeding and selection processes, genotypic and/or phenotypic data can be gathered from inoculated plants, e.g., corn plants, to determine whether particular plants are resistant or susceptible to one or more particular pathogens, such as viral, bacterial or fungal pathogens. Additionally, such genotypic and/or phenotypic data can be gathered from the infected plants to screen and select plants that possess a particular genetic trait that are resistant to one or more such pathogens, and/or to classify a level of susceptibility or resistance of particular plants to one or more such pathogens. For example, by infecting corn stalks with stalk rot, the efficacy of stalk rot resistant genetic traits of various disease resistant hybrid and/or inbred corn plants can be tested.

Known methods and systems for infecting plants are typically tedious manual processes that are hand performed by manually injecting plants with the pathogen, manually spraying the pathogen on plants, or manually applying liquid pathogen to a manually abraded leaf. Such hand performed inoculation methods are typically ergonomically unfriendly, the inoculation throughput rate is very low, and the accuracy/consistency of inoculation is typically sporadic. For example, one known system and method utilizes a syringe to directly inject an inoculum into the stalk of each test plant, which is very labor intensive, ergonomically unfriendly, time consuming, and yields inconsistent and/or inaccurate data due to the uncontrolled amount of inoculum injected into the stalks.

### SUMMARY

The present disclosure provides an automated mobile inoculation system and method for introducing a pathogen into the tissue of a plurality of plants at a high-throughput for disease phenotyping and/or genotyping.

In various embodiments, the automated mobile inoculation system includes a chassis having a plurality of wheels rotationally mounted thereto such that the system is terrestrially mobile. The system additionally includes an inoculum dispensing system structured and operable to controllably dispense an inoculum comprising a desired pathogen onto a target zone of each of a plurality of plants in opposing rows of plants in a plot as the system traverses the ground between the opposing rows of plants. The system further includes at least two abrading arm assemblies connected to the chassis and biased outward, away from the chassis, wherein the abrading arm assemblies are structured and operable to puncture, lacerate, cut and/or abrade the target zone of each plant as the system traverses the ground between the opposing rows of plants.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is an isometric view of an exemplary automated mobile inoculation system for introducing a pathogen into the tissue of a plurality of plants for disease phenotyping and/or genotyping, in accordance with various embodiments of the present disclosure.

FIG. 2 is an isometric view of the automated mobile inoculation system shown in FIG. 1 structured and operable to be manually propelled, in accordance with various embodiments of the present disclosure.

FIG. 3 is an isometric view of a pinwheel of the automated mobile inoculation system shown in FIG. 1, in accordance with various embodiments of the present disclosure.

FIG. 4 is an illustration of the automated mobile inoculation system shown in FIG. 1 positioned between a pair of opposing rows of plants to be inoculated utilizing the mobile inoculation system, in accordance with various embodiments of the present disclosure.

FIG. 5 is an isometric view of the automated mobile inoculation system shown in FIG. 1 structured and operable to be self-propelled, in accordance with various other embodiments of the present disclosure.

FIG. 6 is an isometric view of a pinwheel cover of the automated mobile inoculation system shown in FIG. 1, in accordance with various embodiments of the present disclosure.

FIG. 7 is table illustrating exemplary plant infection data compiled utilizing the automated mobile inoculation system shown in FIG. 1 to inoculate a test plot of plants, in accordance with various embodiments of the present disclosure.

FIG. 8 is a block diagram of the automated mobile inoculation system shown in FIG. 1, in accordance with other embodiments of the present disclosure.

FIG. 9 is an isometric view of the automated mobile inoculation system shown in FIG. 5 including a pair of plant deflectors, in accordance with various other embodiments of the present disclosure.

FIG. 10 is an isometric view of the automated mobile inoculation system shown in FIG. 5 including a centering guide, in accordance with various other embodiments of the present disclosure.

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements.

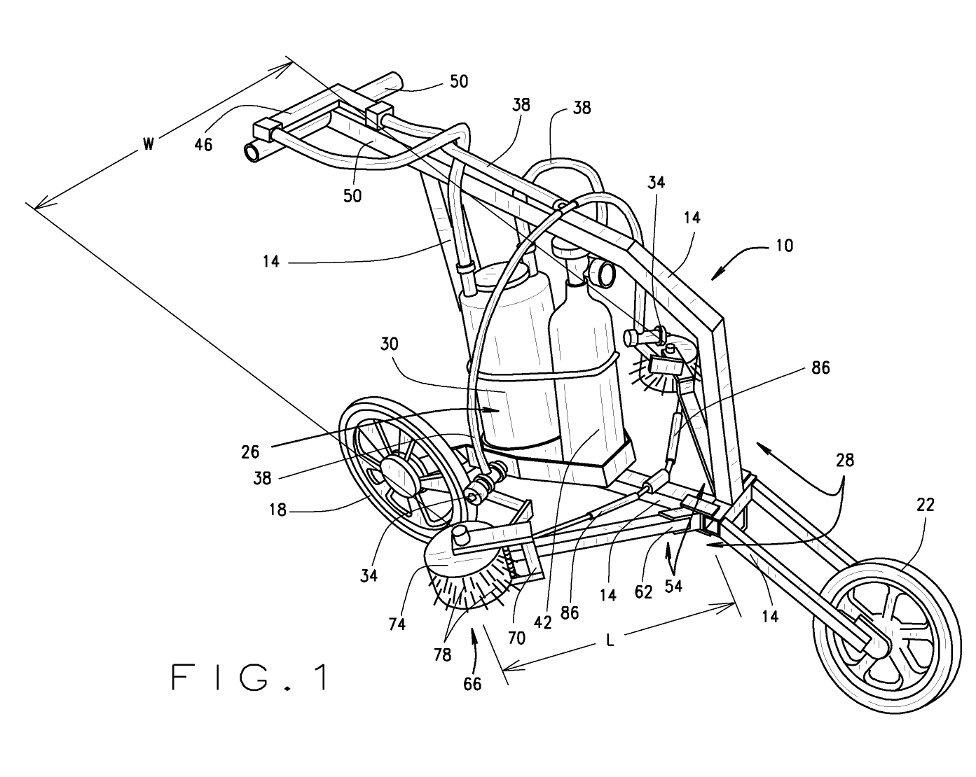

Referring to FIG. 1, the present disclosure provides an automated mobile inoculation system (AMIS) 10 that is structured and operable to inoculate a plurality of plants by introducing pathogens, e.g., bacterial, viral or fungal pathogens, into the plant tissue for disease phenotyping and/or genotyping. For example, the AMIS 10 can be employed to inoculate an entire test plot of plants with one or more stalk rot pathogens such as Anthracnose (Colletotrichum Graminicola), Fusarium, Gibberella or Diplodia. Additionally, it is envisioned that the AMIS 10 can be employed to inoculate plants for foliar disease pathogens such as Goss' wilt, Stewart's wilt, Gray Leaf Spot, Southern Leaf Blight, Northern Leaf Blight, common rust, etc.

More particularly, the AMIS 10, as disclosed herein, can be utilized to infect a plurality of plants at a high throughput rate with a substantially high rate of infection and a substantially consistent level of infection for all the plants. For example, the AMIS 10 can be employed to infect the stalks, or leaves, of an entire test plot of corn plants with Anthracnose at a high throughput rate with a substantially high rate of infestation and a substantially consistent level of infection for all the corn plants.

The inoculum sprayed by the AMIS 10 is a concentrated spore solution comprising particular disease spores mixed in suspension solution or media, e.g., a viscous or agar solution or media. More particularly, the inoculum can be formulated with a concentration of disease spores for infecting the test plants with any desired type of stalk rot or foliar disease pathogen such as Anthracnose or Fusarium, or Goss' wilt, Stewart's wilt, Gray Leaf Spot, Southern Leaf Blight, Northern Leaf Blight, common rust, etc. In various embodiments, the inoculum can include a surfactant to improve adhesion of the inoculum on the plant surfaces sprayed with the inoculum, as described below.

In various embodiments, AMIS 10 generally includes a chassis 14 structured to support one or more rear wheels 18 rotatably mounted to a back of the chassis 14, one or more front wheels 22 rotatably mounted to a front of the chassis 14, an inoculum dispensing system 26 and a plant abrading system 28. The front and rear wheels 22 and 18 allow the AMIS 10 to be terrestrially mobile, i.e., traverse the ground, i.e., capable of being rolled or driven across the ground, and more particularly through a plot of plants. The inoculum dispensing system 26 includes an inoculum tank 30 for retaining a quantity of inoculum, at least two inoculum spray nozzles 34 for controllably dispensing a spray of inoculum, a plurality of inoculum flow tubes 38 operable to provide a flow of inoculum from the inoculum tank 30 to the inoculum spray nozzles 34, an inoculum propellant apparatus 42 for generating a flow of inoculum from the inoculum tank 30 to the nozzles 34, via the flow tubes 38, and a dispensing control device 46 for controlling the flow of inoculum from the inoculum tank 30 to the nozzles 34.

In various embodiments, the AMIS 10 additionally includes a control and steering handle 50 mounted to the back of the chassis 14 that is structured and operable to control movement and steering of the AMIS 10. In various implementations, the dispensing control device 46 can be mounted to or near the control and steering handle 50.

The plant abrading system 28 generally includes a pair of biased abrading arm assemblies 54 extending from opposing sides of the chassis 14. Each abrading arm assembly 54 includes a retracting arm 58 and at least one pinwheel 66 having a plurality of sharply pointed abrading pins 78 extending from an exterior thereof. As described herein, the plant abrading system 28, i.e., the abrading arm assemblies 54 with the pinwheels 66, is structured and operable to puncture, lacerate, cut and/or abrade a target zone of each of a plurality plant stalks in each of the adjacent rows of a plot of plants as the AMIS 10 travels along a row or path between rows of plants. Additionally, as described herein, the inoculum dispensing system 26 is structured and operable to spray inoculum on the wounded area of the plants, i.e., the punctured, lacerated, cut and/or abraded a target zones, such that the inoculum will contact the pith of each plant and thereby infect each plant with the selected pathogen.

Referring now to FIGS. 1, 2 and 3, the retracting arm 58 of each abrading arm assembly 54 is pivotally connected at a proximal end 62 to a respective side of the chassis 14 and a pinwheel 66 is rotationally mounted to a distal end 70 of the respective retracting arm 58. Each pinwheel 66 comprises a cylindrical drum 74 that is rotationally mounted at a center axis to the distal end 70 of the retracting arm 58 and a plurality of the sharply pointed abrading pins 78 extending outward from an outer wall 82 of the respective drum 74. In various embodiments, the abrading pins 78 extend substantially orthogonally from respective drum 74. Each pin wheel 66 can comprise any desirable number of abrading pins 78 that extend from the outer wall 82 of the respective drum 74 in any desired pattern. Additionally, the abrading pins 78 can have any desired length and each pin wheel 66 can comprise abrading pins 78 on one or more lengths extending from the drum wall 82 in one or more patterns.

Furthermore, each abrading arm assembly 54 includes a biasing device 86 pivotally connected at a first end to the chassis 14 and pivotally connected at an opposing second end to the respective retracting arm 58 such that the respective retracting arm 58 and pinwheel 66 are biased outward, away from the chassis 14. The biasing devices 86 can be any biasing device suitable to exert a contractible, or elastic, force on the respective retracting arm 58 such that the respective retracting arm 58, and more importantly the respective pinwheel 66, is pushed outward, away from the chassis 14 with a desired amount of biasing force, e.g., 15 lbs to 45 lbs, but can be pushed inward, toward the chassis 14 with a force greater than the biasing force. Hence, each retracting arm 58 is pivotal at the respective proximal end 62, via the pivotal connection to the chassis 14, such that each respective pinwheel 66 is pushed outward, away from the chassis 14 with the desired amount of force, via the biasing devices 86, but can be temporarily retracted or pushed inward, toward the chassis 14 when a force greater than the biasing force is applied to the respective pinwheel 66 or retracting arm 58. For example, in various embodiments, the biasing devices 86 can comprise a pneumatic actuator or piston (e.g., an air spring) a coil spring, a leaf spring, or any other suitable biasing device.

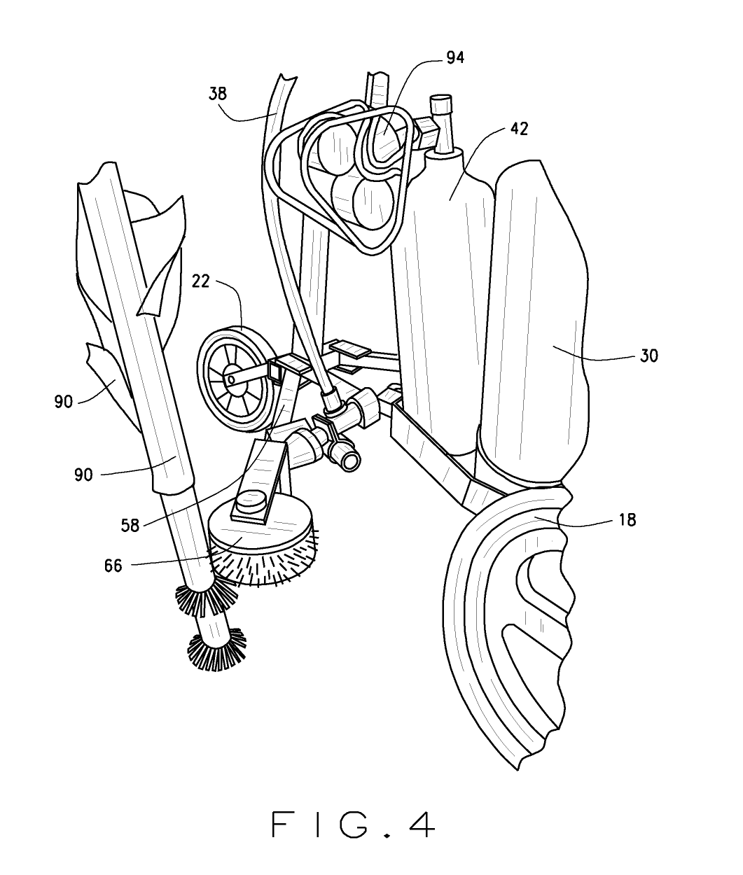

Referring now to FIGS. 1, 2, 3 and 4, additionally, the retracting arms 58 have a length L that is predetermined to provide a maximum wingspan W between opposing pinwheels 66 that is wider than a distance between adjacent rows of plants 90 in a test field for which the AMIS 10 is to be utilized, as described below. More particularly, the retracting arm lengths L are such that when the biasing devices 86 push the retracting arms 58 away from the chassis 14 to a maximum extension, i.e., the biasing devices are fully extended or expanded, the maximum wingspan W is such that the pinwheels 66, and more importantly the abrading pins 78, contact a target zone, i.e., a lower portion between the first and second nodes, of the stalk of each plant 90 in each of the adjacent rows when the AMIS is pushed along the furrow or path between the adjacent rows of plants 90. The biasing devices 86 are retractable, contractable or recoilable, much like a shock absorber, so that contact with the plant stalks will push the retracting arms 58 inward toward the chassis 14, thereby causing the biasing devices 86 to momentarily retract or recoil until movement of the AMIS 10 along the furrow or path causes the respective pinwheel 66 to be removed from contact with respective plant stalk. At which point, the respective biasing device 86 will expand or extend to maximum extension again such that the opposing pinwheels 66 are returned to the maximum wingspan W position.

In various embodiments, the retracting arms 58 are structured to be extendable, e.g., telescopic, such that the respective length L can be adjusted, and hence, the wingspan W can be increased or decreased in accordance with the distance between the respective rows of plants to be inoculated utilizing the AMIS 10, as described herein. Alternatively, in various embodiments, the biasing devices 86 can have an adjustable length that can be increased or decreased in order to increase or decrease the wingspan W to accommodate the width of the respective plant row. Furthermore, in various embodiments, it is envisioned that the abrading arm assemblies 54 can be structured to allow the height of the pinwheels 66 above the ground to be increased or decreased. Therefore, the location of wounds inflicted by AMIS 10 on the respective stalks can be raised or lowered as desired.

It should be understood that each retracting arm 58 and corresponding biasing device 86 work independently of the opposing retracting arm 58 and corresponding biasing device 86. That is, as one pinwheel 66 is contacting the stalk of a plant 90 and the respective biasing device 86 is retracted/contracted/recoiled as the respective retracting arm 58 is being pushed inward by the plant stalk, the opposing pinwheel 66 may be coming off of a stalk and no longer be in contract with the stalk such that the respective biasing device 86 expands/extends and the respective retracting arm 58 is pushed outward by the respective biasing device 86.

Additionally, in various embodiments, the forces exerted by the biasing devices 86 on the respective retracting arm 58 can be adjustable to increase or decrease the force with which the pinwheels 66 contact the plant stalks as the AMIS 10 travels along the furrow or path between the adjacent rows of plants 90.

In general operation, an operator fills the inoculum tank 30 with the desired inoculum and connects the inoculum flow tubes 38 to the inoculum tank 30. The operator then positions the AMIS 10 at the beginning of a furrow or path between opposing rows of plants 90. Subsequently, the operator begins to push the AMIS 10 along the furrow or path, or steer the AMIS 10 along the furrow or path if the AMIS 10 is self-propelled, and activates the dispensing control device 46 such that inoculum propellant apparatus 42 causes the inoculum to be drawn from the inoculum tank 30, flow through the inoculum flow tubes 38 and be dispensed, i.e., sprayed, from the spray nozzles 34.

As the AMIS travels along the furrow or path the pinwheels 66, and more importantly the abrading pins 78, contact and puncture, lacerate, cut and/or abrade the target zone of each plant stalk in each of the adjacent rows. Moreover, prior to, substantially simultaneously with, and/or subsequently to, each plant stalk being punctured, lacerated, cut and/or abraded, the inoculum is sprayed from the nozzles 34 onto the target zone of the stalks at the location where the stalks have been punctured, lacerated, cut and/or abraded. Accordingly, the inoculum will penetrate into the punctures, lacerates, cuts and/or abrasions such that the respective pathogen is introduced into each of the plants 90 in each of the adjacent rows. Each of the nozzles 34 can be any nozzle suitably structured and operable to dispense the inoculum in a substantially even and consistent field of spray.

For example, in various embodiments, the nozzles 34 are twin jet nozzles that are structured and operable to spray two separate fields of spray directed away from each other at a particular angle, e.g., 45°. Therefore, each stalk will be sprayed with the inoculum just prior to being punctured, lacerated, cut and/or abraded by the pinwheels 66 and then sprayed again just after being punctured, lacerated, cut and/or abraded by the pinwheels 66. Thus, the prior inoculum spray will coat the stalk rind and can be pushed into the plant as the abrading pins 78 puncture, lacerate, cut and/or abrade the stalk, and then the subsequent spray can enter the wounds after the abrading pins puncture, lacerate, cut and/or abrade the stalk. In various other embodiments, this same affect can be achieved by mounting two single jet nozzles at the distal ends 70 of the retracting arms 58 such that the nozzles 34 are directed away from each other at a particular angle, e.g., 45°. Alternatively, in various embodiments, the AMIS 10 can include one single jet nozzle 34 mounted at the distal end 70 of each retracting arm 58 such that each stalk is sprayed with inoculum just prior to, substantially simultaneously with, or just subsequent to the abrading pins 78 puncturing and/or abrading the stalk of each plant 90.

Additionally, in various embodiments, the nozzles 34 are structured and operable to dispense the inoculum in a field of spray that includes the respective pinwheel 66 and abrading pins 78. Hence, the abrading pins 78 are coated with the inoculum prior to puncturing and/or abrading the stalk of each plant 90 such that the inoculum is substantially injected into the pith of each plant 90.

Importantly, the biasing devices 86 are structured and operable to exert an outward force on each of the retracting arms 58 such that when the abrading pins 78 contact each plant stalk, the abrading pins 78 are pushed into the stalks with a force sufficient to cause the abrading pins 78 to penetrate the rind of each stalk, generally about 1/16 to ⅛ inch thick, and enter the pith of the stalks. Hence, the pith of each stalk is exposed and susceptible to contact with inoculum such that the respective pathogen will readily infect each plant 90.

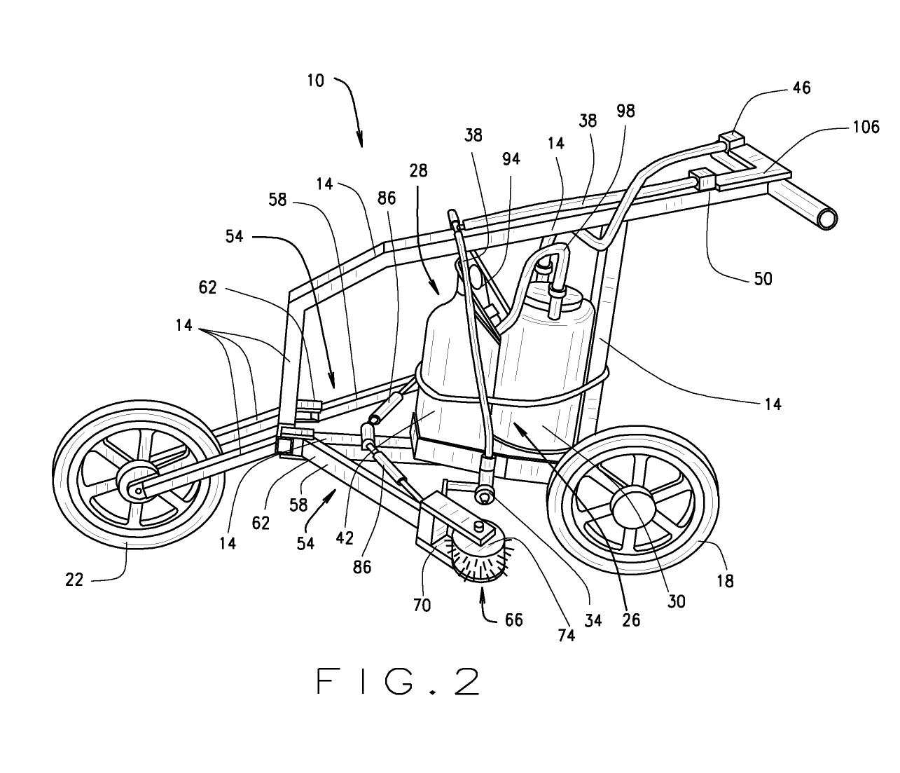

Referring now to FIG. 2, in various embodiments, the AMIS 10 is structured and operable to be a manually propelled automated mobile inoculation system, that is, it is structured and operable to be manually pushed along the furrow or path between the adjacent rows of plants 90 by an operator. In such embodiments, the inoculum tank 30 can comprise at least one 2-6 liter or larger canister and the inoculum propellant apparatus 42 can comprise at least one propellant tank structured to retain a quantity of pressurized propellant, e.g., pressurized CO₂. Additionally, in such embodiments, the inoculum dispensing system 26 can further include a pressure regulator 94 that is structured and operable to control the release of pressurized propellant from the propellant tank(s) 42 such that the pressurized propellant is released at a regulated pressure. More particularly, the propellant is released from propellant tanks(s) 42 at a selectable regulated pressure, e.g., 15-30 psi, and directed into the inoculum canister(s) 30 via a propellant conduit 98, e.g., flexible pressure tubing.

Furthermore, in such embodiments, the dispensing control device 46 can comprise a flow control gun that is fluidly connected to the inoculum canister(s) 30 via a feed hose 102, e.g., flexible hose or tubing. The flow control gun 46 is structured and operable to receive, via the feed hose 102, the inoculum forced from the inoculum canister(s) 30 at the selected regulated pressure by the propellant directed from the propellant tank(s) 42 into the inoculum canister(s) 30. Moreover, the flow control gun 46 is structured and operable to controllably dispense the received inoculum at the selected regulated pressure into the inoculum flow tubes 38 upon activation, e.g., depression, of a trigger mechanism 106 of the control gun 46. The inoculum will then flow through the inoculum flow tubes 38 to the spray nozzles 34, whereby the inoculum is dispensed, i.e., sprayed, onto the plant stalks just prior to, substantially simultaneously with, and/or just subsequent to the respective stalks being punctured, lacerated, cut and/or abraded by the respective pinwheel 66.

Hence, as the operator begins to push the AMIS 10 along the furrow or path, the operator will depress the flow control gun trigger mechanism 106 so that the inoculum is sprayed from the spray nozzles 34, at the regulated pressure, onto the target zone of each plant stalk just prior to, substantially simultaneously with, and/or just subsequent to the target zone of respective stalk being punctured, lacerated, cut and/or abraded by the respective pinwheel 66. Importantly, the nozzles 34 are mounted on the retracting arms 58 such that the inoculum dispensed from each respective nozzle 34 is sprayed on substantially the same area of each stalk that will be, is being, and/or has been punctured, lacerated, cut and/or abraded by the respective pinwheels 66. Therefore, the inoculum will penetrate the stalk rind of each plant stalk at a substantially consistent rate and thereby provide substantially consistent and reliable infection data.

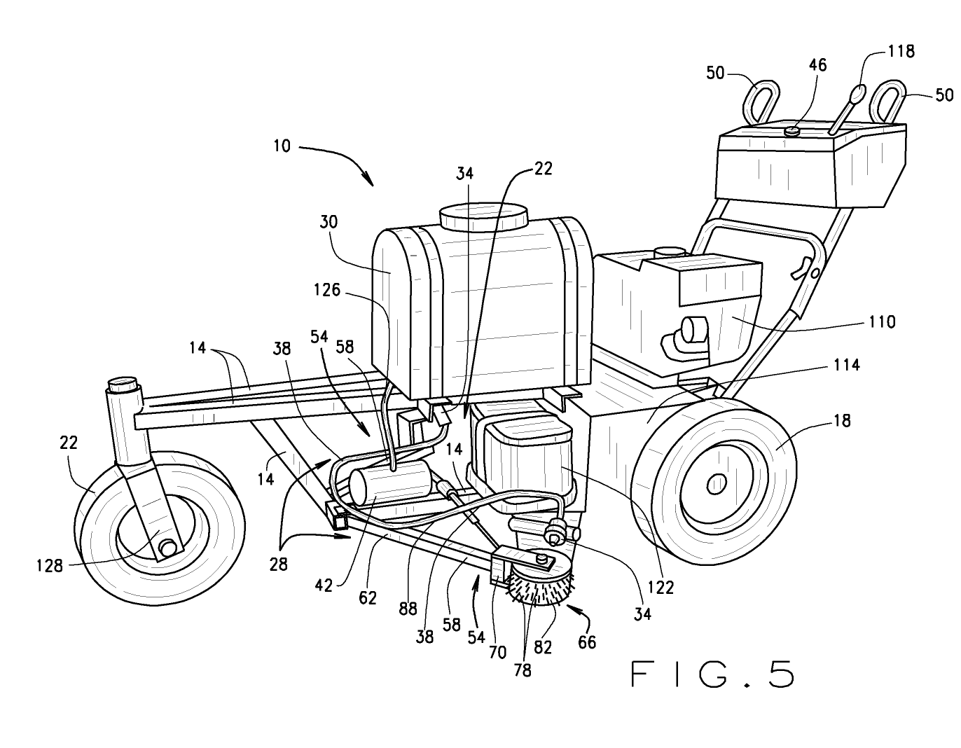

Referring now to FIG. 5, in various embodiments the AMIS 10 is structured and operable to be a self-propelled automated mobile inoculation system. In such embodiments, the AMIS 10 includes a motor 110 that is structured and operable to generate torque that is deliverable to a torque transfer assembly 114 that is connectable to at least one of the rear wheels 18 and structured and operable to transfer the torque generated by the motor 110 to the rear wheel(s) 18. Accordingly, when operating, the motor 110 will cause the rear wheel(s) 18 to rotate to self-propel the AMIS 10 along the furrow or path when the torque transfer assembly 114 is engaged with the rear wheel(s) 18. Engagement and disengagement of the torque transfer assembly 114 with the rear wheel(s) 18 is controlled via an engagement control 118 disposed on or near the control and steering handle 50.

In such embodiments, the inoculum tank 30 can comprise at least one 5-10 gallon inoculum reservoir and the inoculum propellant apparatus 42 can comprise an electric pump electrically connected to a battery power source 122. Additionally, in such embodiments, the dispensing control device 46 can comprise a switch mounted on or near the control and steering handle 50. Specifically, the electric pump 42 is electrically connected to the battery power source 122 via the pump control switch 46 such that activation and deactivation of the electric pump 42 can be controlled by the switch 46. More particularly, the electric pump 42 can be turned ON, i.e., electrical current can be supplied to the electric pump 42 from the battery power source 122, via the operation of the switch 46. Similarly, the electric pump 42 can be turned OFF, i.e., the supply of electrical current to the electric pump 42 from the battery power source 122 can be terminated, via the operation of the switch 46.

When the switch 46 is operated to turn the electric pump 42 ON, the electric pump 42 will receive inoculum from the inoculum reservoir 30, via a feed tube 126, e.g., flexible hose or tubing, connected at one end to the inoculum reservoir 30 and at an opposing end to the electric pump 42. The electric pump 42 will then pump inoculum, or force a flow of inoculum, into the inoculum flow tubes 38. The inoculum will then flow through the inoculum flow tubes 38 to the spray nozzles 34, whereby the inoculum is dispensed, i.e., sprayed, onto the plant stalks just prior to, substantially simultaneously with, and/or just subsequent to the respective stalks being punctured, lacerated, cut and/or abraded by the respective pinwheel 66.

In various implementations, the electric pump 42 is structured and operable to pump the inoculum into the inoculum flow tubes 38 at a selectable regulated pressure, e.g., 15-30 psi. Accordingly, the electric pump 42 will cause the inoculum to flow through the inoculum flow tubes 38 to the spray nozzles 34 and be dispensed, i.e., sprayed, onto the plant stalks just prior to, substantially simultaneously with, and/or just subsequent to the respective stalks being punctured, lacerated, cut and/or abraded by the respective pinwheel 66 at the selected pressure.

Hence, once the operator positions the AMIS 10 at the beginning of a furrow or path, the operator will engage the torque transfer assembly 114 with the rear wheel(s) 18 utilizing the engagement control 118 causing the rear wheel(s) 18 to automatically turn and begin self-propelling the AMIS 10 along the respective furrow or path. Additionally, just before or just after engaging the torque transfer assembly 114, the operation will activate the electric pump 42 utilizing the switch 46 to begin spraying the inoculum from the nozzles 34, at the regulated pressure.

As described above, as the AMIS 10 moves along the furrow or path, the inoculum will be sprayed onto the target zone of each plant stalk just prior to, substantially simultaneously with, and/or just subsequent to the respective stalks being punctured, lacerated and/or abraded by the respective pinwheel 66. Importantly, the nozzles 34 are mounted on the retracting arms 58 such that the inoculum dispensed from each respective nozzle 34 is sprayed on substantially the same area of each stalk that will be, is being, and/or has been punctured, lacerated, cut and/or abraded by the respective pinwheels 66. Therefore, the inoculum will penetrate the stalk rind of each plant stalk at a substantially consistent rate and thereby provide substantially consistent and reliable infection data.

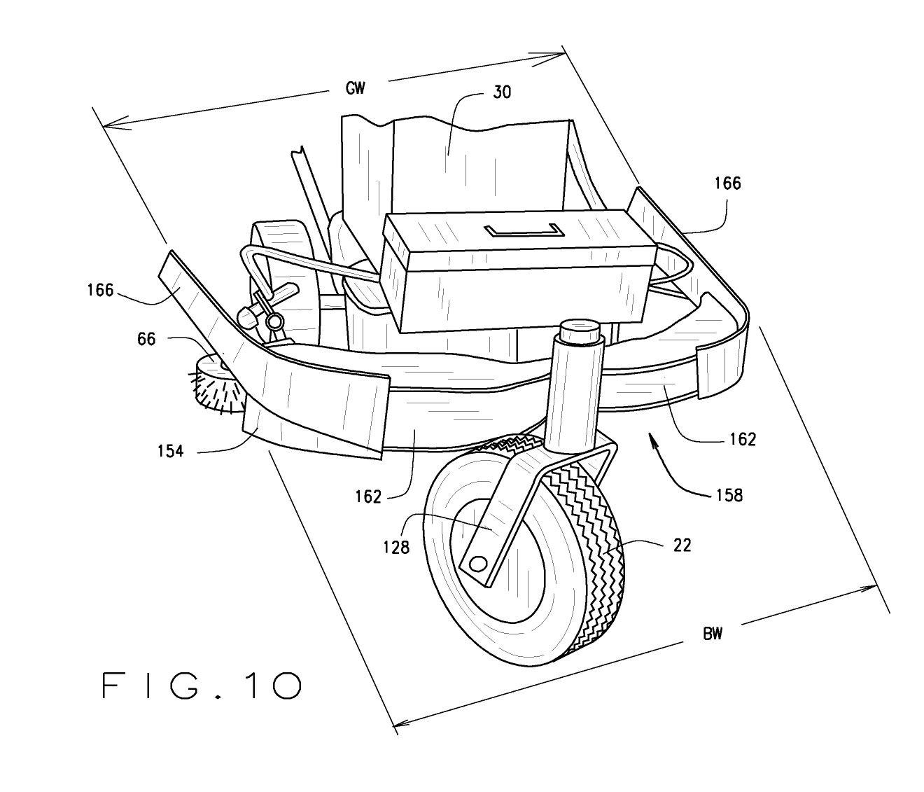

Additionally, in various embodiments, the one or more front wheels 22 can be rotatably mounted with a corresponding one or more forks 128 that is pivotally mounted to the front of the chassis 14 such that the front wheel(s) 22 can swivel to aid the steering of the AMIS 10. However, in various implementations, the AMIS 10 can include one or more front wheel locks 132 (indicated in FIG. 10) that is/are structured and operable to controllably lock the fork(s) 128 in a desired position, such that the front wheel(s) 22 will not swivel.

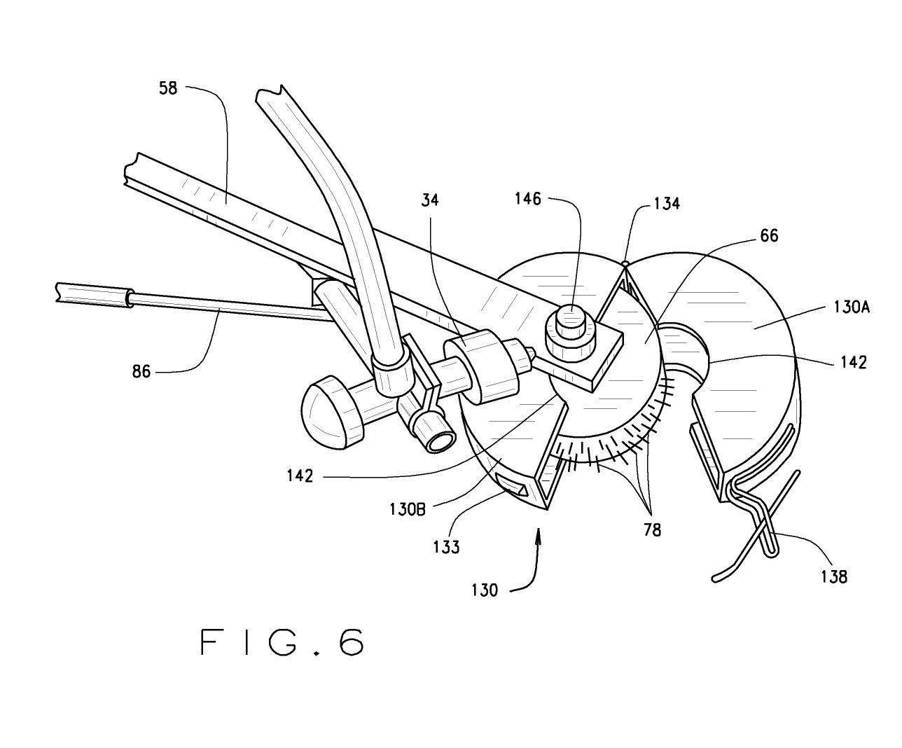

Referring now to FIG. 6, in various embodiments, the AMIS 10 can include removable pinwheel covers 130 structured and operable to cover the pinwheels 66 when the AMIS 10 is not in use. Particularly, the pinwheel covers 130 protect the abrading pins 78 from being damaged by foreign objects and from causing damage to foreign objects and from injuring someone when the AMIS 10 is not being used. In various embodiments, the pinwheel covers 130 are structured as a two-piece housing having a first half 130A and a second half 130B that are hingedly connected via a hinge 134. Hence, the first and second halves can be pivotally opened and closed in a clam-shell manner. Additionally, each pinwheel cover 130 can include a clasp mechanism 138 disposed on a distal end of each of the first and second halves 130A and 130B, i.e., the ends of the first and second halves 130A and 130B opposite the hinge 134. The clasp mechanism 138 is structured and operable to retain the respective pinwheel cover 130 around the respective pinwheel 66. Furthermore, each of the first and second halves 130A and 1308 include semi-circular cutout 142 in each of a lower and an upper wall of the respective first and second halves 130A and 130B. The cutouts 142 are sized to provide space for a shaft 146 of the respective pinwheel to extend through the respective pinwheel cover 130 when the respective pinwheel cover 130 is closed around the respective pinwheel 66.

Accordingly, to install the pinwheel covers 130, the clasp mechanism 138 is released and the first and second halves 130A and 1308 are pivotally opened or separated about the hinge 134. Either the first half 130A or the second half 130B is placed over a first half of the respective pinwheel 66 and then the remaining first or second half 130A or 130B is pivotally closed over a second half of the respective pinwheel 66, thereby encompassing and enclosing the respective pinwheel 66 within the closed pinwheel cover 130. Subsequently, the clasp mechanism 138 can be operated to retain the first and second halves 130A and 130B in the closed position around the respective pinwheel 66. The clasp mechanism can be any fastening device suitable to retain the first and second halves 130A and 130B in the closed position.

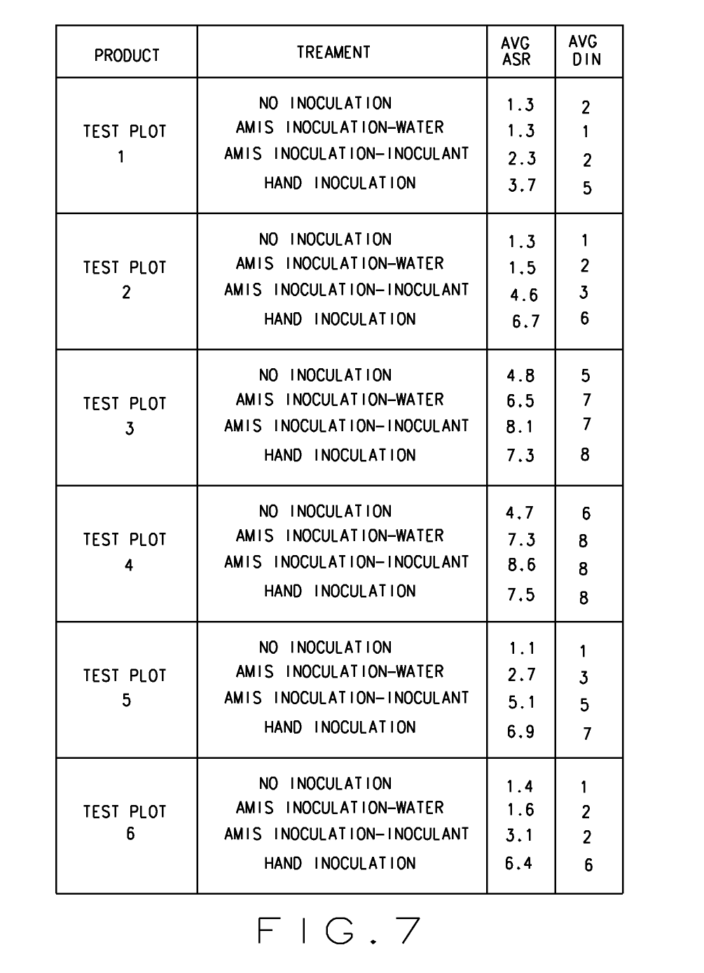

FIG. 7 illustrates the average necrosis for six test plots of corn plants that were infected with Anthracnose stalk rot (ASR) utilizing the AMIS 10, as described herein. Each test plot consisted of 12 rows of a particular hybrid of corn plants (each plot comprising a different hybrid), wherein each row comprised 14 such corn plants. Selected rows of each test plot were inoculated utilizing the AMIS 10 with water being sprayed from the nozzles 34 and selected other rows were inoculated with inoculum being sprayed from the nozzles 34. The inoculum was prepared at a concentration of 250,000 spores/ml from freshly grown oatmeal-agar plates. Additionally, selected rows were used as the control group, whereby the selected rows were not inoculated using the AMIS 10, and selected rows were used as a contrast group, whereby the selected rows were inoculated using a known hand (i.e., non-automated) inoculation method of directly injecting inoculum into each selected stalk using a hand operated syringe.

In FIG. 7, the average Anthracnose stalk rot (AVG ASR) was calculated using the following formula:

AVG ASR=Σ(NNI+NN74)/n,

wherein NNI is the number of stalk nodes infected, NN75 is the number of stalk nodes with >75% necrosis (at least 5 stalks were evaluated in each row), and n is the number of stalks evaluated in each row. Also, in FIG. 7, DIN represents the disease development on inoculation node and AVG DIN represents the average DIN for the respective test plot.

As illustrated in FIG. 7, the automated mobile inoculation system 10 and method of use described herein provide an effective, efficient, consistent, high-throughput and ergonomic way to inoculate plants, e.g. corn stalks, with pathogens for disease analyses.

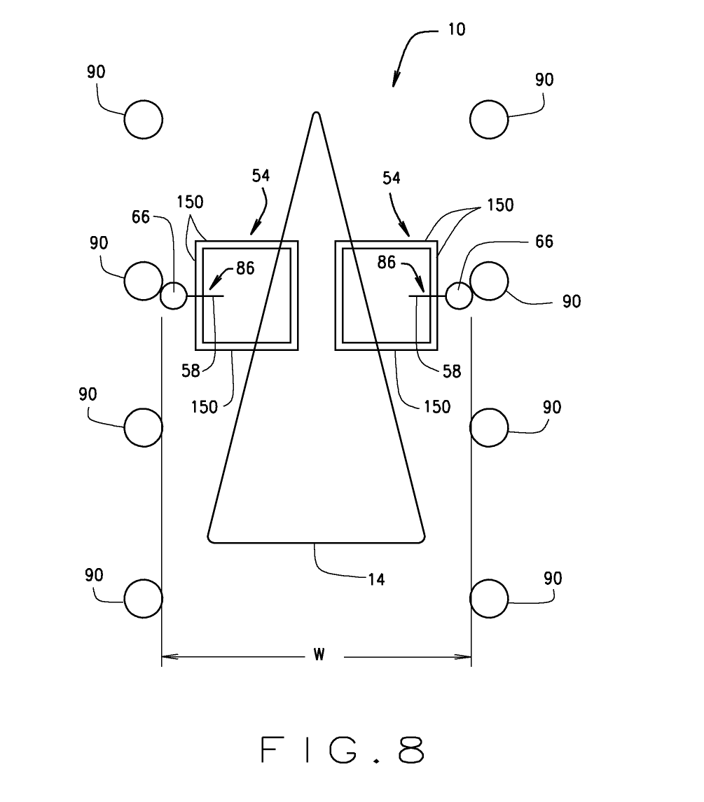

Referring now to FIG. 8, in various other embodiments, each abrading arm assembly 54 can comprise a bracket 150 mounted to the chassis 14 and each retracting arm 58 can include a shaft having the respective pinwheel 66 rotationally mounted at the distal end. Each shaft is biasingly mounted to the respective bracket 150 such that each shaft is biased by the respective biasing device 86 to extend away from the chassis 14 and respective bracket 150 with a desired amount of outward force, but can be retractably pushed inward toward the chassis 14 and bracket 150 as each pinwheel 66 punctures, lacerates, cuts and/or abraded the plants 90, as described above. Additionally, each shaft is adjustably mounted within the respective bracket 150 such that the wingspan W of the abrading arm assemblies 54 can be adjusted to accommodate the distance between the opposing rows of plants 90.

It is envisioned that in various embodiments, the pinwheels 66 and abrading pins 78 can be structured and operable to allow the inoculum to flow through the abrading pins 78 and be dispensed at the tip of each abrading pin 78. Accordingly, the inoculum would be injected by the abrading pins 78 into the stalk of each plant 90.

It is further envisioned that in various embodiments, the AMIS 10 can include one or more sensors, e.g., electronic or laser proximity sensors or any other suitable sensing device, that are operable to detect the presence of a stalk about to be contacted by the respective pinwheel 66 and to control the dispensing of the inoculum from the respective spray nozzle 34. Hence, the sensor would turn on the spray of inoculum for a critical period just before, during and/or just after a stalk is punctured, lacerated, cut and/or abraded by the respective pinwheel 66, and then turn off the spray of inoculum after the critical period has passed. Therefore, the spray of inoculum would be turned off between stalks and conserve the amount of inoculum utilized. In various embodiments, one or more such sensors can be mounted on each side of the chassis 14 at a location forward of the respective spray nozzles 34 such that each sensor(s) detects the presence of a plant stalk and controls the dispensing of the inoculum from the respective spray nozzle 34 so that the inoculum is sprayed on each respective stalk as described above. Hence, each spray nozzle 34 is independently controlled by the respective sensor(s) such that each nozzle 34 is turned On, i.e., dispenses inoculum, at the appropriate time to spray each stalk as described above, and turned Off, i.e., inoculum is prevented from being dispensed from the respective nozzle 34, at the appropriate time to prevent spraying the inoculum between plant stalks where it is not needed and would be wasted.

It is still further envisioned that in various embodiments, the AMIS 10 can be structured such that the distance between the rear wheels 18 can be adjusted to increase or decrease in accordance with the distance between the respective opposing rows of plants 90. Hence, the footprint or wheel base of the AMIS 10 can be increased or decreased as desired to accommodate the variable distance between the rows of plants 90. Also, it is envisioned that the control and steering handle 50 can be height adjustable to accommodate different heights of operators operating the AMIS 10.

It is yet further envisioned that in other various embodiments, a plurality of AMISs 10, such as those shown in FIG. 2, can be mounted to a larger motor driven machine that can be driven through the test field such that four or more rows of plants can be simultaneously inoculated, via the plurality of AMISs 10. For example, in various embodiments, a plurality of AMISs 10 can be mounted to cantilevered high beams extending outward from a high clearance mobile self-propelled machine.

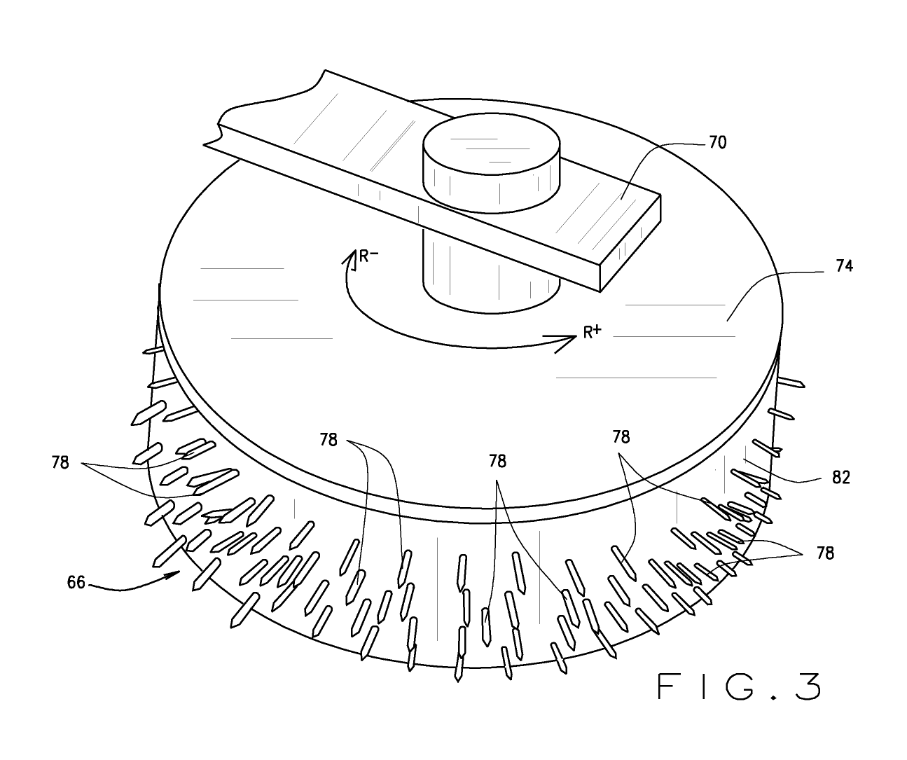

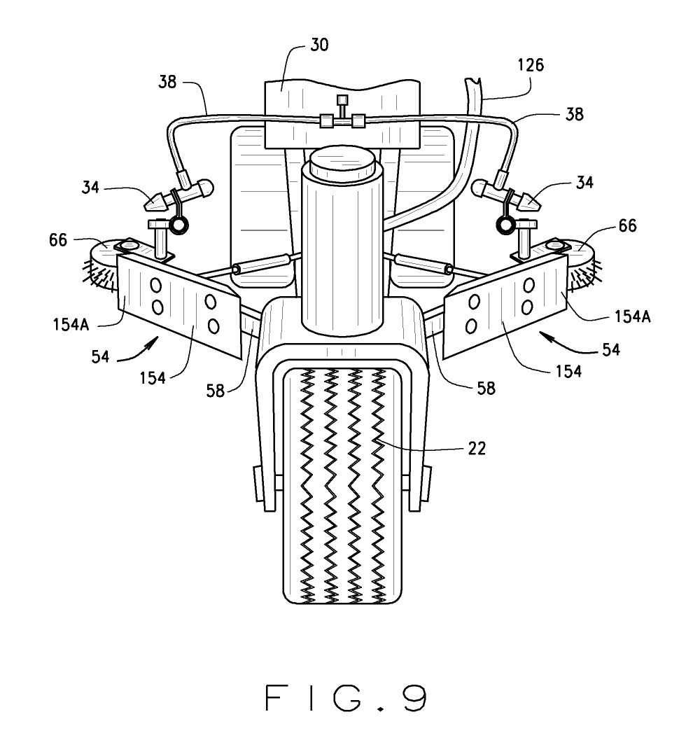

Referring now to FIG. 9, in various embodiments, each abrading arm assembly 54 additionally includes a plant deflector 154 mounted to the respective retracting arm 58. Particularly, each deflector 154 is mounted to a front, forward, or leading, side of the respective retracting arm 58 such that plant stalks that are located within the wingspan W of the abrading arm assemblies 54 will contact the deflectors 154 causing the respective retracting arm 58 to retract, or be pushed inward, toward the chassis 14. Importantly, the deflectors 154 are mounted to the retracting arms 58 such that a distal end 154A of each deflector 154 partially covers the respective pinwheel 66 such that only an exterior, or outermost, portion of the respective pinwheel 66 (i.e., a portion of the pinwheels 66 that extends beyond the distal end 70 of the respective retracting arm 58) is exposed to contact the plant stalks. Accordingly, the pinwheels 66 will contact the stalks, whereby the pinwheels 66 will rotate in the R⁺ direction (see FIG. 3) and roll off the stalks as the AMIS 10 proceeds along the furrow or path. Particularly, the deflectors 154 prevent the stalks from contacting the interior, or innermost, portion of the respective pinwheel 66, whereby the pinwheels 66 would rotate in the R⁻ (see FIG. 3) direction causing the stalks to get caught and lodged between pinwheels 66 and the respective retracting arm 58 and damaging the stalks.

Referring now to FIG. 10, in various embodiments, the AMIS 10 further includes a centering guide 158 structured and operable to assist the operator of the AMIS 10 keep the AMIS 10 substantially centered within the furrow, or path, i.e., between the rows of plants, as the AMIS 10 travels along the furrow, or path. The centering guide 158 is mounted to the front of the AMIS 10 and includes a front bridge 162 that extends laterally across the front of the AMIS 10 behind and/or above the front wheel 22 and a pair of opposing side guides 166 that extend backward from the front bridge 162 (i.e., toward the back wheels 18 of the AMIS 10) along the sides of the AMIS 10. The width BW of the front bridge 162 is less than the wingspan W of the abrading arm assemblies 54. And furthermore, the side guides 166 extend backward along the sides of the AMIS 10 such that the exterior, or outermost, portions of the pinwheels 66 extend laterally beyond the side guides 166 and are exposed to readily and easily contact the plant stalks as the AMIS travels along the furrow, or path, between opposing rows of plants.

More specifically, the width WB of the front bridge 162 is less than the known row width of the plants, i.e., the known distance between opposing rows of plants. For example, in various embodiments, the bridge width BW is only slightly less, e.g., 2-6 inches less, than the known row width. Accordingly, as the AMIS 10 travels along a furrow, or path, the front bridge 162 and/or the side guides 166 will contact the stalks in a plow-like manner, such that the opposing rows of plants act as walls that keep the front of the AMIS 10 from skewing too far laterally, i.e., side-to-side, thereby keeping the AMIS 10 substantially centered between the opposing plant rows as the AMIS 10 travels along the furrow, or path. That is, the front bridge 162 and the leading parts of the side guides 166, i.e., the parts of the side guides 166 nearest the front of the AMIS 10, keep the front of the AMIS 10 substantially centered between the opposing rows of plants as the AMIS travels along the furrow, or path.

Keeping the AMIS 10 centered between the opposing plant rows prevents the AMIS 10 from contacting the plant stalks in a hard, abrupt and/or blunt, i.e., less than tangential, manner, which could cause stalk lodging, i.e., uprooting, dislodgment, or breaking of the plant stalks. Rather, as a result of keeping the AMIS 10 centered between the opposing plant rows, the AMIS 10, particularly the front bridge 162, the side guides 166 and pin wheels 66 will contact the stalks in an indirect, glancing manner, thereby reducing the occurrence of stalk lodging.

Additionally, in various embodiments, the front bridge 162 can have a rounded shape, as exemplarily illustrated in FIG. 10, such that the front bridge 162 will not abruptly, or bluntly contact with the stalks, but will rather contact the stalks in an indirect, glancing manner, thereby reducing the occurrence of stalk lodging. Furthermore, in various embodiments, the side guides 166 can extend backward from the front bridge in a slightly flared manner. That is, a guide width GW at the distal ends of the side guides 166 is greater than bridge width BW and substantially equal to, or slightly less than, the known row width of the plants. The flared side guides 166 serve to stabilize and center the back end of the AMIS 10 between the opposing plant rows as the AMIS 10 travels along the along the furrow, or path. Still further, in various implementations, the side guides 166 can be constructed of a rigid but flexible material that allows the side guides 166 to flex as the side guides contact the plant stalks, as described below. Further yet, in various embodiments, the front bridge 162 and/or the side guides 166 can be adjustably mounted to the chassis 14 such that the bridge width BW and/or the gate width GW can be adjustable to accommodate different row widths, i.e., the distance between the respective rows of plant stalks. Still further yet, in various embodiments, the AMIS 10 can be constructed such that the distance between the rear wheels 18 can be adjusted to accommodate different row widths.

When introducing elements or features of embodiments herein, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

The description herein is merely exemplary in nature and, thus, variations that do not depart from the gist of that which is described are intended to be within the scope of the teachings. Such variations are not to be regarded as a departure from the spirit and scope of the teachings.

1. An automated mobile inoculation system for inoculating a plurality of plants with a desired pathogen at a high-throughput, said system comprising:
a chassis having a plurality of wheels rotationally mounted thereto such that the system is terrestrially mobile;
an inoculum dispensing system structured and operable to controllably dispense an inoculum comprising a desired pathogen onto a target zone of each of a plurality of plants in opposing rows of plants in a plot as the system traverses the ground between the opposing rows of plants; and
at least two abrading arm assemblies, each pivotally connected to the chassis and biased outward, away from the chassis, the abrading arm assemblies structured and operable to at least one of puncture, lacerate, cut and abrade the target zone of each plant as the system traverses the ground between the opposing rows of plants.

2. The system of claim 1, wherein each abrading arm assembly comprises:
a retracting arm pivotally connected at a proximal end to the chassis;
a biasing device connected to the retracting arm, the biasing device structured and operable to exert and outward force on the retracting arm to push a distal end of the retracting arm outward, away from the chassis; and
at least one pinwheel rotationally mounted at the distal end of the retracting arm, each pinwheel having a plurality of sharpened abrading pins extending from an outer cylindrical wall of the respective pinwheel, the abrading pins structured and operable to at least one of puncture, lacerate, cut and abrade the target zone of each plant upon contacting the target zones, as the system traverses the ground between the opposing rows of plants.

3. The system of claim 2, wherein each abrading arm assembly further comprises a deflector mounted to the respective retracting arm, each deflector structured and operable to prevent the plants from being caught between the respective retracting arm and the respective pinwheel.

4. The system of claim 2, wherein the inoculum dispensing system comprises:
an inoculum tank structured to retain a quantity of inoculum;
a plurality of spray nozzles, at least one nozzle mounted at the distal end of each retracting arm, the nozzles structured and operable to dispense inoculum from the inoculum tank onto the target zone of the plants as the system traverses the ground between the opposing rows of plants; and
an inoculum propellant apparatus structured and operable to transport the inoculum from the inoculum tank to the nozzles, via inoculum flow tubes, at a selected pressure such that the inoculum is dispensed from the nozzles onto the target zone of the plants at the selected pressure.

5. The system of claim 4, wherein the inoculum propellant apparatus comprises at least one propellant tank structured to retain a quantity of pressurized propellant, and the inoculum dispensing system further comprises a pressure regulator that is structured and operable to control the release of the pressurized propellant from the at least one propellant tank such that inoculum is dispensed from the nozzles onto the target zone of the plants at the selected pressure.

6. The system of claim 4, wherein the inoculum dispensing system further comprises a battery power source and the inoculum propellant apparatus comprises an electric pump electrically connected to the battery power source, wherein the pump is structured and operable to propel the inoculum from the inoculum tank to the nozzles, such that the inoculum is dispensed from the nozzles onto the target zone of the plants at the selected pressure.

7. The system of claim 4 further comprising:
a torque transfer assembly structured and operable to selectably engage with at least one of the wheels; and
a motor coupled to the torque transfer assembly and structured and operable to generate torque that is deliverable to the at least one wheel when the torque transfer assembly is selectably engaged such that the at least one wheel will rotate to self-propel the system along the ground between the opposing rows of plants.

8. The system of claim 1 further comprising a centering guide mounted to a front of the chassis, the centering guide structured and operable to utilize the opposing rows of plants as walls to keep the system substantially centered between the opposing rows of plants as the system traverses the ground between the opposing rows of plants.

9. An automated mobile inoculation system for inoculating a plurality of plants with a desired pathogen at a high-throughput, said system comprising:
a chassis having a plurality of wheels rotationally mounted thereto such that the system is terrestrially mobile;
an inoculum dispensing system structured and operable to controllably dispense an inoculum comprising a desired pathogen onto a target zone of each of a plurality of plants in opposing rows of plants in a plot as the system traverses the ground between opposing rows of plants;
at least two abrading arm assemblies, each pivotally connected to the chassis and biased outward, away from the chassis, the abrading arm assemblies structured and operable to at least one of puncture, lacerate, cut and abrade the target zone of each plant as the system traverses the ground between the opposing rows of plants; and
a centering guide mounted to a front of the chassis, the centering guide structured and operable to utilize the opposing rows of plants as walls to keep the system substantially centered between the opposing rows of plants as the system traverses the ground between the opposing rows of plants.

10. The system of claim 9, wherein each abrading arm assembly comprises:
a retracting arm pivotally connected at a proximal end to the chassis;
a biasing device connected to the retracting arm, the biasing device structured and operable to exert and outward force on the retracting arm to push a distal end of the retracting arm outward, away from the chassis; and
at least one pinwheel rotationally mounted at the distal end of the retracting arm, each pinwheel having a plurality of sharpened abrading pins extending from an outer cylindrical wall of the respective pinwheel, the abrading pins structured and operable to at least one of puncture, lacerate, cut and abrade the target zone of each plant upon contacting the target zones, as the system traverses the ground between the opposing rows of plants.

11. The system of claim 10, wherein each abrading arm assembly further comprises a deflector mounted to the respective retracting arm, each deflector structured and operable to prevent the plants from being caught between the respective retracting arm and the respective pinwheel.

12. The system of claim 10, wherein the inoculum dispensing system comprises:
an inoculum tank structured to retain a quantity of inoculum;
a plurality of spray nozzles, at least one nozzle mounted at the distal end of each retracting arm, the nozzles structured and operable to dispense inoculum from the inoculum tank onto the target zone of the plants as the system traverses the ground between the opposing rows of plants; and
an inoculum propellant apparatus structured and operable to transport the inoculum from the inoculum tank to the nozzles, via inoculum flow tubes, at a selected pressure such that the inoculum is dispensed from the nozzles onto the target zone of the plants at the selected pressure.

13. The system of claim 12, wherein the inoculum propellant apparatus comprises at least one propellant tank structured to retain a quantity of pressurized propellant, and the inoculum dispensing system further comprises a pressure regulator that is structured and operable to control the release of the pressurized propellant from the at least one propellant tank such that inoculum is dispensed from the nozzles onto the target zone of the plants at the selected pressure.

14. The system of claim 12, wherein the inoculum dispensing system further comprises a battery power source and the inoculum propellant apparatus comprises an electric pump electrically connected to the battery power source, wherein the pump is structured and operable to propel the inoculum from the inoculum tank to the nozzles, such that the inoculum is dispensed from the nozzles onto the target zone of the plants at the selected pressure.

15. The system of claim 12 further comprising:
a torque transfer assembly structured and operable to selectably engage with at least one of the wheels; and
a motor coupled to the torque transfer assembly and structured and operable to generate torque that is deliverable to the at least one wheel when the torque transfer assembly is selectably engaged such that the at least one wheel will rotate to self-propel the system along the ground between the opposing rows of plants.

16. A method for inoculating a plurality of plants with a desired pathogen at a high-throughput, said method comprising:
advancing an automated mobile inoculation system along the ground between opposing rows of plants in a plot;
controllably dispensing an inoculum comprising a desired pathogen onto a target zone of each of the plants in the opposing rows utilizing an inoculum dispensing system of the mobile inoculation system, as the mobile inoculation system is advanced between the opposing rows of plants; and
at least one of puncturing, lacerating, cutting and abrading the target zone of each plant in the opposing rows utilizing at least two abrading arm assemblies of the mobile inoculation system, as the mobile inoculation system advances between the opposing rows of plants, each abrading arm assembly pivotally connected to a chassis of the mobile inoculation system and biased outward, away from the chassis.

17. The method of claim 16, wherein the at least one of puncturing, lacerating, cutting and abrading the target zone of each plant in the opposing rows comprises:
biasing a distal end of a retracting arm of each abrading arm assembly outward, away from the chassis, utilizing a biasing device connected to the retracting arm, such that at least one pinwheel rotationally mounted to the distal end of each retracting arm contacts the target zone of each plant in the opposing rows as the mobile inoculation system advances between the opposing rows of plants; and
utilizing a plurality of sharpened abrading pins extending from an outer cylindrical wall of each pinwheel to at least one of puncture, lacerate, cut and abrade the target zone of each plant as the mobile inoculation system advances between the opposing rows of plants.

18. The method of claim 17, wherein the at least one of puncturing, lacerating, cutting and abrading the target zone of each plant in the opposing rows comprises preventing the plants from being caught between the respective retracting arm and the respective pinwheel utilizing a deflector mounted to the respective retracting arm.

19. The method of claim 17, wherein advancing an automated mobile inoculation system along the ground between opposing rows of plants comprises:
operating a motor of the of the mobile inoculation system to generate torque that is deliverable to a torque transfer assembly of the mobile inoculation system, wherein the torque transfer assembly is structured and operable to selectably engage with at least one of a plurality of the wheels of the mobile inoculation system; and
engaging the torque transfer assembly with at least one of the plurality of wheels such that the at least one wheel will rotate and propel the mobile inoculation system along the ground between the opposing rows of plants.

20. The method of claim 16 further comprising keeping the mobile inoculation system substantially centered between the opposing rows of plants as the mobile inoculation system advance between the opposing rows of plants utilizing a centering guide mounted to a front of the chassis, wherein the centering guide is structured and operable to utilize the opposing rows of plants as walls to maintain a front of the mobile inoculation system substantially centered between the opposing rows of plants.
